(19) United States
(12) Patent Application Publication
(10) Pub. No.: US 2025/0146858 A1
(43) Pub. Date: May 8, 2025

(54) ESTIMATING A HYDROGEN LOADING INDUCED CHANGE IN A VIBRATORY METER

(71) Applicant: MICRO MOTION, INC., Boulder, CO (US)

(72) Inventor: Kevin M. SCOTT, Lyons, CO (US)

(73) Assignee: MICRO MOTION, INC., Boulder, CO (US)

(21) Appl. No.: 18/837,746

(22) PCT Filed: Mar. 9, 2022
(86) PCT No.: PCT/US2022/019462

§ 371 Date: Aug. 12, 2024

(51) Int. Cl. G01F 25/10; G01F 1/84

(52) U.S. Cl. CPC G01F 25/15; G01F 1/8431; G01F 1/8436

(57) ABSTRACT

A method for estimating a hydrogen loading induced change in a vibratory meter is provided. The method comprises determining a pressure and a temperature of hydrogen exposed to a vibratory element of the vibratory meter. The method also comprises calculating, based on the pressure and the temperature of the hydrogen, a concentration of the hydrogen in the vibratory element and adjusting a calibration coefficient of the vibratory meter based on the calculated concentration of the hydrogen in the vibratory element.

### TECHNICAL FIELD

The embodiments described below relate to estimating changes in a vibratory meter and, more particularly, to estimating a hydrogen loading induced change in a vibratory meter.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring fluid parameters. Generally, vibratory meters comprise a sensor assembly and a meter electronics. A sensor assembly may be communicatively coupled to the meter electronics and provide sensor signals to the meter electronics. The sensor assembly may include conduits configured to vibrate in response to a driving force imposed by an actuator that receives a drive signal from the meter electronics. The actuator may be referred to as a driver.

When the conduits are used in the sensor assembly, the conduits may be filled with material having properties to be measured. The material within the conduit or conduits of the sensor assembly may be flowing or stationary. The sensor assembly may be used to measure one or more fluid parameters such as mass flow rate, density, or other properties of a material in the sensor assembly. More specifically, there may be one or more transducers affixed to the conduit or conduits configured to convert vibratory motion into sensor signals. These transducers may be referred to as pick-off sensors. The pick-off sensors are typically located at inlet and outlet portions of the conduit or conduits.

As noted above, the vibratory meter may be a Coriolis flow meter. The Coriolis flow meter includes one or more conduits that are connected inline in a pipeline or other transport system and convey material, e.g., fluids, slurries, and/or the like, in the system. Each conduit may be viewed as having a set of natural vibration modes including, for example, simple bending, torsional, radial, and coupled modes. In a Coriolis flow measurement application, a conduit is excited in one or more vibration modes as material flows through the conduit, and motion of the conduit is measured at points spaced along the conduit. During flow, the vibrating tube and the flowing mass couple together due to Coriolis forces, causing a phase difference in the vibration between the ends of the tube. The phase difference may be directly proportional to the mass flow and may be measured as a phase difference between two sensor signals provided by the pick-off sensors.

For example, the mass flow rate of the material may be proportional to a phase difference or the time delay between the two sensor signals, where the time delay may comprise a phase difference divided by frequency. The mass flow rate can therefore be determined by, for example, multiplying the time delay by a proportionality constant or calibration factor, which may be referred to as a Flow Calibration Factor (FCF). The FCF may reflect the material properties and mechanical properties of the flow tube. The FCF may be determined by a calibration process prior to installation of the flow meter into a pipeline or other conduit. In the calibration process, a material is flowed through the conduit at a known flow rate and a proportionality constant between the phase difference or time delay and the flow rate is calculated and recorded as the FCF. A similar procedure may be used to calibrate a density meter where a time-period is the independent variable rather than a time delay.

The vibratory meters may be employed in processes where the process fluid includes hydrogen, such as a hydrogen rich or pure fluid. Hydrogen is known to be able to diffuse into a metal lattice, such as, for example, steel lattice, under certain conditions. The diffusion of the hydrogen into the metal lattice can have a significant effect on material properties of the metal. Some of the changes can be an increase in an elastic modulus (e.g., a ratio of stress versus strain). If the increase in elastic modulus increases significantly, the result can be hydrogen assisted cracking of the metal. This issue may alternatively be referred to as hydrogen induced cracking, embrittlement, etc.

Metals may be fabricated that are sufficiently resistant to hydrogen loading as to not experience hydrogen assisted cracking. However, such metals may still experience enough hydrogen loading to change the material properties of the metal. The change to the material properties may be significant enough to cause an error in a measurement of a vibratory meter. With more particularity, the vibratory meter may employ calibration coefficients that relate a parameter value of a vibratory element (e.g., time delay, frequency, etc.) with a measured value of a fluid property of the fluid being measured, such as mass flow rate, density, viscosity, or the like. When a material property of the vibratory element changes, the calibration coefficients may no longer accurately relate a parameter value of the vibratory element to a measured value of a fluid property.

Although such changes may be accounted for by recalibrating the vibratory meter, a calibration can be undesirable for various reasons, such as manual labor being required in hazardous environments or costs associated with taking the vibratory meter offline. Such risks and costs can be minimized and, accordingly, a return on investment maximized by accurately assessing whether a calibration is required. Furthermore, the calibration coefficients may be adjusted by quantifying a change to the material property that has a known relationship with the calibration coefficient. Accordingly, there is a need to estimate a hydrogen loading induced change in a vibratory meter.

### SUMMARY

A method for estimating a hydrogen loading induced change in a vibratory meter is provided. According to an embodiment, the method comprises determining a pressure and a temperature of hydrogen exposed to a vibratory element of the vibratory meter, calculating, based on the pressure and the temperature of the hydrogen, a concentration of the hydrogen in the vibratory element, and adjusting a calibration coefficient of the vibratory meter based on the calculated concentration of the hydrogen in the vibratory element.

A vibratory meter configured to estimate a hydrogen loading induced change in the vibratory meter is provided. According to an embodiment, the vibratory meter comprises a sensor assembly having a vibratory element configured to be exposed to hydrogen in a process fluid, a meter electronics communicatively coupled to the sensor assembly. The meter electronics is configured to determine a pressure and a temperature of the hydrogen, calculate, based on the pressure and the temperature of the hydrogen, a concentration of the hydrogen in the vibratory element, and adjust a calibration coefficient of the vibratory meter based on the calculated concentration of the hydrogen in the vibratory element.

### Aspects

According to an aspect, a method for estimating a hydrogen loading induced change in a vibratory meter comprises determining a pressure and a temperature of hydrogen exposed to a vibratory element of the vibratory meter, calculating, based on the pressure and the temperature of the hydrogen, a concentration of the hydrogen in the vibratory element, and adjusting a calibration coefficient of the vibratory meter based on the calculated concentration of the hydrogen in the vibratory element.

Preferably, the vibratory element is one of a conduit and a tine.

Preferably, the process fluid is one of a pure fluid of the hydrogen and a mixture containing the hydrogen.

Preferably, determining a pressure of the hydrogen comprises determining one of a total pressure of the pure fluid of the hydrogen and a partial pressure of the hydrogen in the mixture.

Preferably, the hydrogen is in at least one of a gas phase and a liquid phase and/or in at least one of a molecular form and an atomic form.

Preferably, calculating the concentration of the hydrogen in the vibratory element comprises calculating an average concentration as a fraction of an equilibrium concentration.

Preferably, adjusting the calibration coefficient of the vibratory meter comprises calculating a change in an elastic modulus of the vibratory element based on the concentration of the hydrogen in the vibratory element and calculating an elastic modulus scaled calibration coefficient based on the change in the elastic modulus.

Preferably, calculating the change in the elastic modulus of the vibratory element comprises using equation:

$$Δ E = μ ( {C}_{{H}_{2}} * \overline{C} ) ;$$

where:
ΔE is a change in elastic modulus of a metal;
μ is an elastic modulus-to-concentration change ratio;
C_{H}_{₂} is an equilibrium concentration of hydrogen; and
C̅ is a fraction of the equilibrium concentration of the hydrogen in the metal.

Preferably, calculating the elastic modulus scaled calibration coefficient based on the change in the elastic modulus comprises using equation:

$${FCF}^{′} = FCF [ 1 + \frac{Δ E}{E} ] ;$$

where:
FCF is a reference flow calibration factor;
FCF′ is an elastic modulus scaled flow calibration factor;
E is a reference elastic modulus or an elastic modulus that resulted in the reference flow calibration factor; and
ΔE is a change in elastic modulus of the vibratory element from the reference elastic modulus E.

Preferably, calculating the elastic modulus scaled calibration coefficient based on the change in the elastic modulus comprises using the equation:

$${C}_{1}^{′} = {C}_{1} [ 1 + \frac{Δ E}{E} ] ;$$

where:
C₁ is a reference first calibration coefficient;
C₁′ is an elastic modulus scaled first calibration coefficient;
E is a reference elastic modulus or an elastic modulus that resulted in the reference first calibration coefficient; and
ΔE is a change in elastic modulus of the vibratory element from the reference elastic modulus E.

A vibratory meter configured to estimate a hydrogen loading induced change in the vibratory meter comprises a sensor assembly having a vibratory element configured to be exposed to hydrogen in a process fluid, a meter electronics communicatively coupled to the sensor assembly. The meter electronics is configured to determine a pressure and a temperature of the hydrogen, calculate, based on the pressure and the temperature of the hydrogen, a concentration of the hydrogen in the vibratory element, and adjust a calibration coefficient of the vibratory meter based on the calculated concentration of the hydrogen in the vibratory element.

Preferably, the vibratory element is one of a conduit and a tine.

Preferably, the process fluid containing the hydrogen is one of a pure fluid of the hydrogen and a mixture containing the hydrogen.

Preferably, the meter electronics being configured to determine a pressure of the hydrogen comprises the meter electronics being configured to determine one of a total pressure of the pure fluid of the hydrogen and a partial pressure of the hydrogen in the mixture.

Preferably, the hydrogen is in at least one of a gas phase and a liquid phase and/or in at least one of a molecular form and an atomic form.

Preferably, the meter electronics being configured to calculate the concentration of the hydrogen in the vibratory element comprises the meter electronics being configured to calculate an elastic modulus of the vibratory element based on the pressure and the temperature of the hydrogen in the process fluid.

Preferably, the meter electronics being configured to adjust the calibration coefficient of the vibratory meter comprises the meter electronics being configured to calculate a change in an elastic modulus of the vibratory element based on the concentration of the hydrogen in the vibratory element and calculating an elastic modulus scaled calibration coefficient based on the change in the elastic modulus.

Preferably, the meter electronics being configured to calculate the change in the elastic modulus of the vibratory element comprises using equation:

$$Δ E = μ ( {C}_{{H}_{2}} * \overline{C} ) ;$$

where:
ΔE is a change in elastic modulus of a metal;
μ is an elastic modulus-to-concentration change ratio;
C_{H}_{₂} is an equilibrium concentration of hydrogen; and
C̅ is a fraction of the equilibrium concentration of the hydrogen in the metal.

Preferably, the meter electronics being configured to calculate the elastic modulus scaled calibration coefficient based on the change in the elastic modulus comprises the meter electronics being configured to use equation:

$${FCF}^{′} = FCF [ 1 + \frac{Δ E}{E} ] ;$$

where:
FCF is a reference flow calibration factor;
FCF′ is an elastic modulus scaled flow calibration factor;
E is a reference elastic modulus or an elastic modulus that resulted in the reference flow calibration factor; and
ΔE is a change in elastic modulus of the vibratory element from the reference elastic modulus E.

Preferably, the meter electronics being configured to calculate the elastic modulus scaled calibration coefficient based on the change in the elastic modulus comprises the meter electronics being configured to use the equation:

$${C}_{1}^{′} = {C}_{1} [ 1 + \frac{Δ E}{E} ] ;$$

where:
C₁ is a reference first calibration coefficient;
C₁′ is an elastic modulus scaled first calibration coefficient;
E is a reference elastic modulus or an elastic modulus that resulted in the reference first calibration coefficient; and
ΔE is the calculated shift in elastic modulus of the vibratory element from the reference elastic modulus E.

### BRIEF DESCRIPTION OF THE DRAWINGS

The same reference number represents the same element on all drawings. It should be understood that the drawings are not necessarily to scale.

FIG. 1 shows a vibratory meter 5 configured to estimate a hydrogen loading induced change in a vibratory meter.

FIG. 2 shows a vibratory meter 5a comprising a Coriolis meter configured to estimate a hydrogen induced change in the vibratory meter 5a.

FIG. 3 shows a block diagram of the vibratory meter 5a described with reference to FIG. 2, including a block diagram representation of the meter electronics 20a, configured to estimate a hydrogen loading induced change to the vibratory meter 5a.

FIG. 4 shows the vibratory meter 5b comprising a fork meter configured to estimate a hydrogen loading induced change in the fork meter.

FIG. 5 shows the meter electronics 20 configured to estimate a hydrogen loading induced change in a vibratory meter 5.

FIG. 6 shows a method 600 of estimating a hydrogen loading induced change in a vibratory meter.

### DETAILED DESCRIPTION

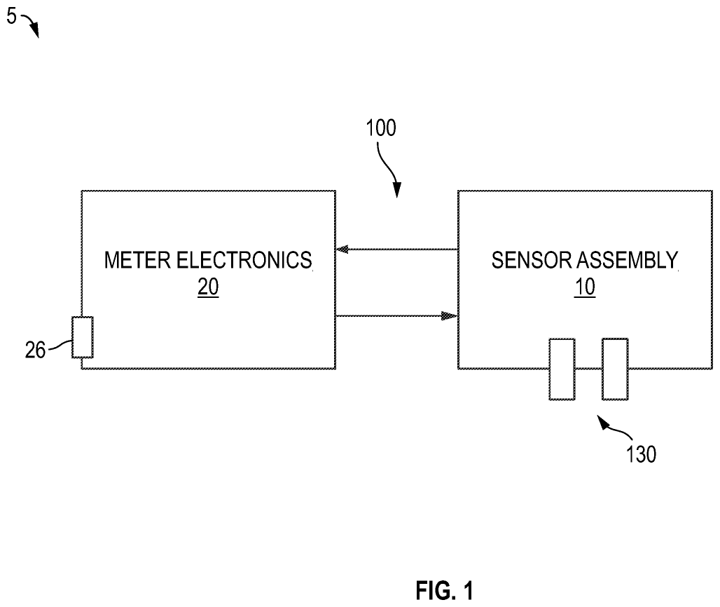

FIGS. 1-6 and the following description depict specific examples to teach those skilled in the art how to make and use the best mode of embodiments of estimating a hydrogen loading induced change in a vibratory meter. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of estimating a hydrogen induced change in a vibratory meter. As a result, the embodiments described below are not limited to the specific examples described below, but only by the claims and their equivalents.

FIG. 1 shows a vibratory meter 5 configured to estimate a hydrogen loading induced change in a vibratory meter. As shown in FIG. 1, the vibratory sensor 5 is comprised of a sensor assembly 10 and a meter electronics 20 that is communicatively coupled to the sensor assembly 10. The sensor assembly 10 may contain, immerse into, be exposed to, or the like, a fluid to be measured. The sensor assembly 10 provides information on the sense property to the meter electronics 20. The information may be provided by electrical signals, optical signals, or the like. The information may be provided by any suitable means, such as, for example, modulating a property (e.g., voltage, current, power, etc.) of an electrical signal. The modulation may be digital, analog, mixed signal, etc. The meter electronics 20 can use the information to convert the information into a measurement. This conversion typically utilizes one or more calibration factors that may offset and/or scale the information into the measurement. The fluid measurement may be comprised of one or more fluid measurement values. Accordingly, the meter electronics 20 can provide the fluid measurement via a port 26, such as a communications terminal, interface, or the like. As will be explained in more detail in the following, the measurement of the fluid can be affected if characteristics of the sensor assembly 10 changes relative to a baseline or reference calibration.

The sensor assembly 10 may be configured to sense a property of the fluid. With more specificity, vibratory elements 130 may be configured to be exposed to the fluid to measure the properties of the fluid. The vibratory elements 130 may include conduits that contain the fluid, such as conduits in a Coriolis meter, tines on a fork meter that is immersed in the fluid, or the like, as is explained in more detail in the following. The properties of the fluid, or the fluid properties, may include a flow rate, such as a mass or volume flow rate, density, viscosity, or the like. The properties of the fluid may also include a temperature, pressure, and/or the like, of the fluid.

The sensor assembly 10 may also be configured to sense non-fluid properties, such as temperature, containment pressure of a housing, and/or vibration frequency of one or more vibratory elements. The sensor assembly 10 may provide information related to the properties of the fluid via the communication channels 100. The sensor assembly 10 may also receive via the communication channels 100, such as a drive signal, from the meter electronics 20.

Additionally, or alternatively, although not shown in FIG. 1, a transducer, such as a temperature and/or pressure transducer, may be mechanically coupled to a container, pipeline, or the like, that is/are coupled with the sensor assembly 10 to sense the fluid that is provided to the sensor assembly 10. Such transducers, which may be referred to as external transducers, may be communicatively coupled to the meter electronics 20 in addition to the sensor assembly 10. The external transducers may provide such information to the meter electronics 20 via, for example, the port 26 shown in FIG. 1, although additional ports or the like may be employed.

### Coriolis Meter

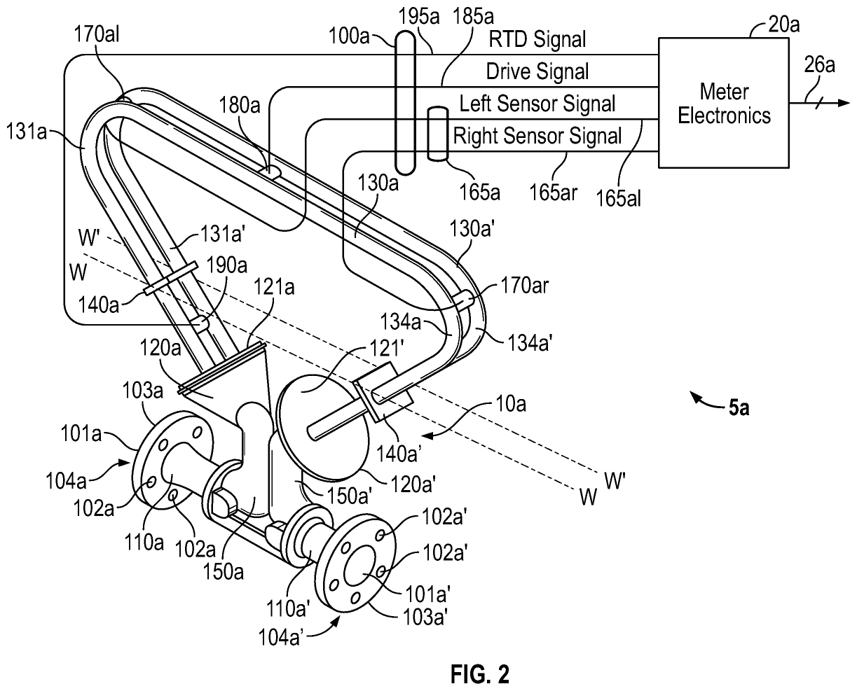

FIG. 2 shows a vibratory meter 5a comprising a Coriolis meter configured to estimate a hydrogen induced change in the vibratory meter 5a. As shown in FIG. 1, the vibratory meter 5a is a Coriolis meter comprising a sensor assembly 10a and meter electronics 20a. The sensor assembly 10a responds to mass flow rate and density of a process material. The meter electronics 20a is connected to the sensor assembly 10a via communication channels 100a, which may be comprised of leads, although any suitable channel may be employed. As can be appreciated, the communication channels 100a include the RTD signal, drive signal, and the left and right sensor signals. The meter electronics 20a may be configured to use the communication channels 100a to calculate and provide density, mass flow rate, temperature information, or the like, over port 26a.

The sensor assembly 10a includes a pair of manifolds 150a and 150a′, flanges 103a and 103a′ having flange necks 110a and 110a′, a pair of conduits 130a and 130a′, driver 180a, resistive temperature detector (RTD) 190a, and a pair of pick-off sensors 170al and 170ar. Conduits 130a and 130a′ have two inlet legs 131a, 131a′ and outlet legs 134a, 134a′, which converge towards each other at conduit mounting blocks 120a and 120a′. The conduits 130a, 130a′ bend at two symmetrical locations along their length and are essentially parallel throughout their length. Brace bars 140a and 140a′ serve to define the axis W and W′ about which each conduit 130a, 130a′ oscillates. The inlet and outlet legs 131a, 131a′ and 134a, 134a′ of the conduits 130a, 130a′ are fixedly attached to conduit mounting blocks 120a and 120a′ and these blocks, in turn, are fixedly attached to manifolds 150a and 150a′. This provides a continuous closed material path through sensor assembly 10a.

When flanges 103a and 103a′, having holes 102a and 102a′ are connected, via inlet end 104a and outlet end 104a′ into a process line (not shown) which carries the process material that is being measured, material enters inlet end 104a of the meter through an orifice 101a in the flange 103a and is conducted through the manifold 150a to the conduit mounting block 120a having a surface 121a. Within the manifold 150a the material is divided and routed through the conduits 130a, 130a′. Upon exiting the conduits 130a, 130a′, the process material is recombined in a single stream within the block 120a′ having a surface 121a′ and the manifold 150a′ and is thereafter routed to outlet end 104a′ connected by the flange 103a′ having holes 102a′ to the process line (not shown).

The conduits 130a, 130a′ are selected and appropriately mounted to the conduit mounting blocks 120a, 120a′ so as to have substantially the same mass distribution, moments of inertia and Young's modulus about bending axes W-W and W′-W′, respectively. These bending axes go through the brace bars 140a, 140a′. Inasmuch as the Young's modulus of the conduits change with temperature, and this change affects the calculation of flow and density, RTD 190a is mounted to conduit 130a′ to continuously measure the temperature of the conduit 130a′. The temperature of the conduit 130a′ and hence the voltage appearing across the RTD 190a for a given current passing therethrough is governed by the temperature of the material passing through the conduit 130′. The temperature dependent voltage appearing across the RTD 190a is used in a well-known method by the meter electronics 20a to compensate for the change in elastic modulus of the conduits 130a, 130a′ due to any changes in conduit temperature. The RTD 190a is connected to the meter electronics 20a by lead 195a.

Both of the conduits 130a, 130a′ are driven by driver 180a in opposite directions about their respective bending axes W and W′ and at what is termed the first out-of-phase bending mode of the vibratory meter. This driver 180a may comprise any one of many well-known arrangements, such as a magnet mounted to the conduit 130a′ and an opposing coil mounted to the conduit 130a and through which an alternating current is passed for vibrating both conduits 130a, 130a′. A suitable drive signal 185a is applied by the meter electronics 20a, via a lead, to the driver 180a.

The meter electronics 20a receives the RTD temperature signal on lead 195a, and sensor signals 165a appearing via communication channels 100a or more particularly left and right sensor signals 165al, 165ar. The meter electronics 20a produces the drive signal 185a appearing on the lead to driver 180a and vibrate conduits 130a, 130a′. The meter electronics 20a processes the left and right sensor signals 165al, 165ar and the RTD signal from lead 195a to compute the mass flow rate and the density of the material passing through sensor assembly 10a. This information, along with other information, is applied by meter electronics 20a over a port 26a as a signal.

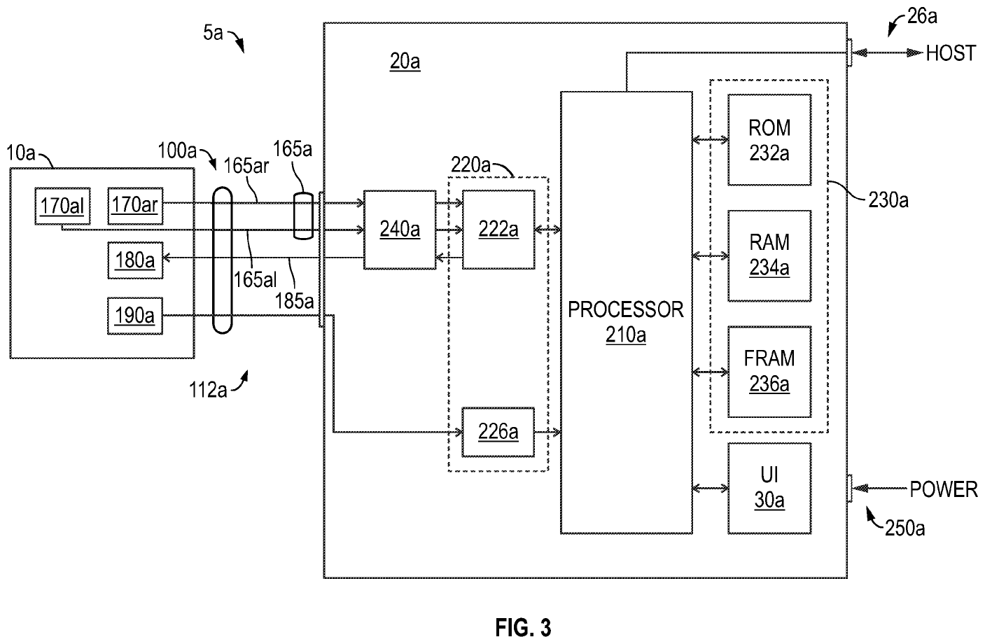

FIG. 3 shows a block diagram of the vibratory meter 5a described with reference to FIG. 2, including a block diagram representation of the meter electronics 20a, configured to estimate a hydrogen loading induced change to the vibratory meter 5a. As shown in FIG. 3, the meter electronics 20a is communicatively coupled to the sensor assembly 10a. As described in the foregoing with reference to FIG. 2, the sensor assembly 10a includes the left and right pick-off sensors 170al, 170ar, driver 180a, and RTD 190a, which are communicatively coupled to the meter electronics 20a via the set of leads through a communications channel 112a.

The meter electronics 20a provides a drive signal 185a via the leads carrying the communication channels 100a. More specifically, the meter electronics 20a provides a drive signal 185a to the driver 180a in the sensor assembly 10a. In addition, sensor signals 165a comprising the left sensor signal 165al and the right sensor signal 165ar are provided by the sensor assembly 10a. More specifically, in the embodiment shown, the sensor signals 165a are provided by the left and right pick-off sensor 170al, 170ar in the sensor assembly 10a. As can be appreciated, the sensor signals 165a are respectively provided to the meter electronics 20a through the communications channel 112a.

The meter electronics 20a includes a processor 210a communicatively coupled to one or more signal processors 220a and one or more memories 230a. The processor 210a is also communicatively coupled to a user interface 30a. The processor 210a is communicatively coupled with the host via a communication port over the port 26a and receives electrical power via an electrical power port 250a. The processor 210a may be a microprocessor although any suitable processor may be employed. For example, the processor 210a may be comprised of sub-processors, such as a multi-core processor, serial communication ports, peripheral interfaces (e.g., serial peripheral interface), on-chip memory, I/O ports, and/or the like. In these and other embodiments, the processor 210a is configured to perform operations on received and processed signals, such as digitized signals.

The processor 210a may receive digitized sensor signals from the one or more signal processors 220a. The processor 210a is also configured to provide information, such as a phase difference, a property of a fluid in the sensor assembly 10a, or the like. The processor 210a may provide the information to the host through the communication port. The processor 210a may also be configured to communicate with the one or more memories 230a to receive and/or store information in the one or more memories 230a. For example, the processor 210a may receive calibration factors and/or sensor assembly zeros (e.g., phase difference when there is zero flow) from the one or more memories 230a. Each of the calibration factors and/or sensor assembly zeros may respectively be associated with the vibratory meter 5a and/or the sensor assembly 10a. The processor 210a may use the calibration factors to process digitized sensor signals received from the one or more signal processors 220a.

The one or more signal processors 220a is shown as being comprised of an encoder/decoder (CODEC) 222a and an analog-to-digital converter (ADC) 226a. The one or more signal processors 220a may condition analog signals, digitize the conditioned analog signals, and/or provide the digitized signals. The CODEC 222a is configured to receive the sensor signals 165a from the left and right pick-off sensors 170a1, 170ar. The CODEC 222a is also configured to provide the drive signal 185a to the driver 180a. In alternative embodiments, more or fewer signal processors may be employed.

As shown, the sensor signals 165a are provided to the CODEC 222a via a signal conditioner 240a. The drive signal 185 is provided to the driver 180a via the signal conditioner 240a. Although the signal conditioner 240a is shown as a single block, the signal conditioner 240a may be comprised of signal conditioning components, such as two or more op-amps, filters, such as low pass filters, voltage-to-current amplifiers, or the like. For example, the sensor signals 165a may be amplified by a first amplifier and the drive signal 185a may be amplified by the voltage-to-current amplifier. The amplification can ensure that the magnitude of the sensor signals 165a is approximate the full-scale range of the CODEC 222a.

In the embodiment shown, the one or more memories 230a is comprised of a read-only memory (ROM) 232a, random access memory (RAM) 234a, and a ferroelectric random-access memory (FRAM) 236a. However, in alternative embodiments, the one or more memories 230a may be comprised of more or fewer memories. Additionally, or alternatively, the one or more memories 230a may be comprised of different types of memory (e.g., volatile, non-volatile, etc.). For example, a different type of non-volatile memory, such as, for example, erasable programmable read only memory (EPROM), or the like, may be employed instead of the FRAM 236a. The one or more memories 230a may be a storage configured to store process data, such as drive or sensor signals, mass flow rate or density measurements, etc.

A mass flow rate measurement can be generated according to the equation:

$$\dot{m} = FCF [ Δ t - Δ {t}_{0} ] ; \qquad [ 1 ]$$

where:
m is a measured mass flow rate;
FCF is a flow calibration factor;
Δt is a measured time delay; and
Δt₀ is a zero-flow time delay.
   The measured time delay Δt comprises an operationally-derived (i.e., measured) time delay value comprising the time delay existing between the pick-off sensor signals, such as where the time delay is due to Coriolis effects related to mass flow rate through the vibratory meter 5a. The measured time delay Δt is a direct measurement of a mass flow rate of the flow material as it flows through the vibratory meter 5a. The zero-flow time delay Δt₀ comprises a time delay at a zero flow. The zero-flow time delay Δt₀ is a zero-flow value that may be determined at the factory and programmed into the vibratory meter 5a. The zero-flow time delay Δt₀ is an exemplary zero-flow value. Other zero-flow values may be employed, such as a phase difference, time difference, or the like, that are determined at zero flow conditions. A value of the zero-flow time delay Δt₀ may not change, even where flow conditions are changing. A mass flow rate value of the material flowing through the vibratory meter 5a is determined by multiplying a difference between measured time delay Δt and a reference zero-flow value Δt₀ by the flow calibration factor FCF. The flow calibration factor FCF is proportional to a physical stiffness of the vibratory meter.

As to density, a resonance frequency at which each conduit 130a, 130a′ may vibrate may be a function of the square root of a spring constant of the conduit 130a, 130a′ divided by the total mass of the conduit 130a, 130a′ having a material. The total mass of the conduit 130a, 130a′ having the material may be a mass of the conduit 130a, 130a′ plus a mass of a material inside the conduit 130a, 130a′. The mass of the material in the conduit 130a, 130a′ is directly proportional to the density of the material. Therefore, the density of this material may be proportional to the square of a period at which the conduit 130a, 130a′ containing the material oscillates multiplied by the spring constant of the conduit 130a, 130a′. Hence, by determining the period at which the conduit 130a, 130a′ oscillates and by appropriately scaling the result, an accurate measure of the density of the material contained by the conduit 130a, 130a′ can be obtained. The meter electronics 20a can determine the period or resonance frequency using the sensor signals 165a and/or the drive signal 185a. The conduits 130a, 130a′ may oscillate with more than one vibration mode. As described above, the vibratory meter 5 may also be a fork meter, an example of which is discussed in the following.

### Fork Meter

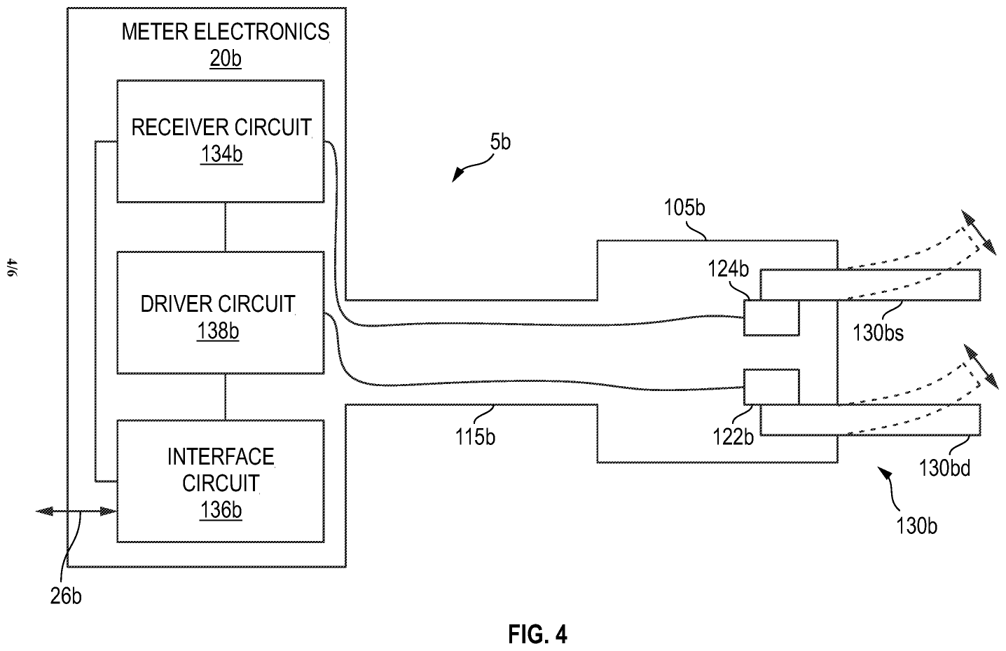

FIG. 4 shows the vibratory meter 5b comprising a fork meter configured to estimate a hydrogen loading induced change in the fork meter. As shown in FIG. 4, the vibratory meter 5b includes a meter electronics 20b that is communicatively coupled to a sensor assembly 10b. The meter electronics 20b is also mechanically coupled to a sensor assembly 10b by a shaft 115b. The shaft 115b may be of any desired length. The shaft 115b may be at least partially hollow. Wires or other conductors may extend between the meter electronics 20b and the vibratory element 130b through the shaft 115b. The meter electronics 20b includes circuit components such as a receiver circuit 134b, an interface circuit 136b, and a driver circuit 138b. In the embodiment shown, the receiver circuit 134b and the driver circuit 138b are directly coupled to the leads of the vibratory element 130b. Alternatively, the meter electronics 20b can comprise a separate component or device from the vibratory element 130b, wherein the receiver circuit 134b and the driver circuit 138b are coupled to the vibratory element 130b via communication channels 100b.

In the embodiment shown, the vibratory element 130b of the vibratory meter 5b comprises a tuning fork structure, wherein the vibratory element 130b is at least partially immersed in the process fluid being measured. The vibratory element 130b includes a housing 105b that can be affixed to another structure, such as a pipe, conduit, tank, receptacle, manifold, or any other fluid-handling structure. The housing 105b retains the vibratory element 130b while the vibratory element 130b remains at least partially exposed to the process fluid. The vibratory element 130b is therefore configured to be immersed in the fluid.

The vibratory element 130b in the embodiment shown includes a first and second tines 130bd and 130bs that are configured to extend at least partially into the fluid. The first and second tines 130bd and 130bs comprise elongated elements that may have any desired cross-sectional shape. The first and second tines 130bd and 130bs may be at least partially flexible or resilient in nature. The vibratory meter 5b further includes corresponding first and second piezo elements 122b and 124b that comprise piezo-electric crystal elements. The first and second piezo elements 122b and 124b are located adjacent to the first and second tines 130bd and 130bs, respectively. The first and second piezo elements 122b and 124b are configured to contact and mechanically interact with the first and second tines 130bd and 130bs.

The first piezo element 122b is in contact with at least a portion of the first tine 130bd. The first piezo element 122b is also electrically coupled to the driver circuit 138b. The driver circuit 138b provides the generated drive signal to the first piezo element 122b. The first piezo element 122b expands and contracts when subjected to the generated drive signal. As a result, the first piezo element 122b may alternatingly deform and displace the first tine 130bd from side to side in a vibratory motion (see dashed lines), disturbing the fluid in a periodic, reciprocating manner.

The second piezo element 124b is shown as coupled to a receiver circuit 134b that produces the vibration signal corresponding to the deformations of the second tine 130bs in the fluid. Movement of the second tine 130bs causes a corresponding electrical vibration signal to be generated by the second piezo element 124b. The second piezo element 124b transmits the vibration signal to the meter electronics 20b. The meter electronics 20b includes the interface circuit 136b. The interface circuit 136b can be configured to communicate with external devices. The interface circuit 136b communicates a vibration measurement signal or signals and may communicate determined fluid characteristics to one or more external devices. The meter electronics 20b can transmit vibration signal characteristics via the interface circuit 136b, such as a vibration signal frequency and a vibration signal amplitude of the vibration signal. The meter electronics 20b may transmit fluid measurements via the interface circuit 136b, such as a density and/or viscosity of the fluid, among other things. Other fluid measurements are contemplated and are within the scope of the description and claims. In addition, the interface circuit 136b may receive communications from external devices, including commands and data for generating measurement values, for example. In some embodiments, the receiver circuit 134b is coupled to the driver circuit 138b, with the receiver circuit 134b providing the vibration signal to the driver circuit 138b. The driver circuit 138b generates the drive signal for the vibratory element 130b. The driver circuit 138b can modify characteristics of the generated drive signal. The vibratory element 130b is generally maintained at a resonant frequency, as influenced by the surrounding fluid.

The vibratory meter 5b comprising the fork meter can measure properties of a fluid, such as density, viscosity, etc. The density, similar to a density determined using the conduits 130a, 130a′ discussed above, can be determined from a period of the vibratory element 130b, as is expressed in the following equation [2]:

$${ρ}_{fluid} = {C}_{1} {τ}^{2} + {C}_{2} ; \qquad [ 2 ]$$

where:
ρ_{fluid} is the fluid density;
C₁ and C₂ are constants; and
τ is the period of fork oscillation.

As can be seen, the fluid density ρ_{fluid} is determined based on the period of the fork and two constants C₁, C₂. The two constants scale and offset the information received from the vibratory element 130b to obtain the density.

The sensor assembly 10 of the vibratory meter 5 may be adversely affected by hydrogen loading of the vibratory elements. For example, the sensor assembly 10a described with reference to FIGS. 2 and 3 include conduits 130a, 130a′ that may contain and convey fluids that include hydrogen. Accordingly, the hydrogen in the fluid may disassociate and adsorb into a lattice of the conduits 130a, 130a′. Similarly, the vibratory element 130b of the vibratory meter 5b may be immersed into a process fluid that includes hydrogen. Accordingly, the hydrogen in the process fluid may adsorb into a lattice of the vibratory element 130b.

The hydrogen loading of vibratory elements can cause a material property, such as an elastic modulus, of the vibratory elements to change. As a result, vibration characteristics of the vibratory element, such as a resonance frequency, period, displacement, etc., of the vibratory elements can correspondingly change. The hydrogen loading can be estimated by determining one or more thermodynamic property values, such as temperature and pressure, of the hydrogen in the process fluid, using the thermodynamic property values to determine a change in the material property of the vibratory element. This change in the material property can be used to adjust a calibration coefficient of the vibratory meter, as the following explains in more detail.

### Effects of Hydrogen Loading on Material Properties

Hydrogen diffusion into a lattice of a metal can affect the material properties of the metal. Typically, a metal may be chosen to reduce or mitigate the effects and/or amount of hydrogen loading in the metal. This can help prevent catastrophic failures, such as hydrogen induced cracking However, some hydrogen may still diffuse into the lattice and may still influence material properties of the metal. This influence on the material properties of the metal may correspondingly influence parameters, such as frequency, relative displacement, time-period, or the like, of the vibratory element of the vibratory sensor. In addition, the hydrogen loading may increase an “internal friction” of metal and therefore the damping coefficient of the vibratory elements may increase. This can increase the drive power required to drive the dynamic elements.

An amount of hydrogen in a metal (e.g., concentration) and a correlation between the amount of hydrogen in the metal and a change in material property may be used to estimate a change in the material property. This estimated change in material property may be used to determine an elastic modulus adjusted calibration factor. The hydrogen loading adjusted calibration factor can be used to determine if the measurements are not valid, a hydrogen loading corrected measurement value, or the like, as will be explained in more detail in the following.

TABLE 1
Change in elastic modulus of steel samples having a hydrogen
loading relative to a sample's hydrogen concentration.
C′ is the measured concentration in the lattice and
Δ is an absolute shift in elastic modulus of a sample.

| Sample | E(GPa) | E′(GPa) | % change | Δ (GPa) | C′ (ppm) |
|---|---|---|---|---|---|
| 316L-1 | 197.046 | 197.086 | 0.02 | 0.041 | 114 |
| 316L-2 | 196.437 | 196.788 | 0.18 | 0.351 | 114 |
| 316L-3 | 196.042 | 196.629 | 0.30 | 0.586 | 132 |
| 316L-4 | 196.245 | 196.946 | 0.36 | 0.701 | 132 |
| XM19-1 | 194.852 | 195.795 | 0.48 | 0.944 | 182 |
| XM19-2 | 194.782 | 195.410 | 0.32 | 0.628 | 182 |
| XM19-3 | 195.767 | 196.497 | 0.37 | 0.730 | 219 |
| XM19-4 | 194.696 | 195.331 | 0.33 | 0.635 | 219 |

The 316L-n and XM-19-n, where “n” represents a sample number, of the “Sample” column are respective samples of 316L and XM-19 steel. These may be suitable for use in vibratory elements in vibratory meters that measure hydrogen process fluids, such as hydrogen gas, due to their resistance to hydrogen assisted cracking mechanism. As can be seen, there is a large overall shift in the elastic modulus of the steel samples due to diffusion of hydrogen into lattice of the steel samples, which may herein be referred to as hydrogen loading. The XM-19 steel samples show a significantly larger change in the elastic modulus than the 316L steel samples. As can be seen from the concentration C′ column, this difference in elastic modulus change may be due to greater diffusion of hydrogen into the lattice of the XM-19 steel samples. This greater diffusion may be due to the XM-19 steel including nitrogen, which can result in greater lattice strain when compared to the 316L steel. As can also be appreciated from Table 1, the change in the elastic modulus can range from 0.30% to 0.50%. In the context of mass flow rate measurements, this change in elastic modulus can correspond to an error contribution that is at least the mass flow rate accuracy specification of the vibratory meter. For example, some vibratory meters that measure a mass flow rate may have a liquid mass flow rate accuracy specification of at or less than 0.1% and a gas mass flow rate accuracy specification of at or less than 0.5%. Therefore, a measurement error caused by hydrogen loading alone may be large enough to invalidate a vibratory meter calibration.

Diffusion of gases, such as hydrogen, into metals, such as steel, may be understood with Fick's second law of diffusion. Assuming a one-dimensional problem, Fick's second law in cylindrical coordinates may be expressed as follows:

$$\frac{\partial C}{\partial t} = \frac{D}{r} \frac{\partial }{\partial r} [ r \frac{\partial C}{\partial r} ] ; \qquad [ 3 ]$$

where:
C is the molar concentration of hydrogen;
D is the diffusivity of hydrogen, assumed to be constant and isotropic; and
r is a radius.
   When the one-dimensional problem is cast in linear coordinates, Fick's second law may be expressed as follows:

$$\frac{\partial C}{\partial t} = D \frac{{\partial }^{2} C}{\partial {x}^{2}} ; \qquad [ 4 ]$$

where x is a linear coordinate.

For Sievert's law, which predicts the solubility of a gas in metal, the equilibrium concentration of hydrogen may be related to the pressure of the hydrogen gas by:

$${C}_{{H}_{2}} = K \sqrt{{p}_{{H}_{2}}} ; \qquad [ 5 ]$$

where:
K is a temperature dependent constant that can be readily calculated; and
P_{H}_{₂} is a time averaged hydrogen pressure.

As can be appreciated, by knowing a temperature and a pressure of the hydrogen, the equilibrium concentration of hydrogen C_{H}_{₂} can be determined. Additionally or alternatively, other relationships, such as empirical relationships, equations, numerical methods, or the like, may be employed to determine an equilibrium concentration.

The temperature may be temperature of a process fluid, such as a mixture that includes hydrogen, although any suitable temperature may be employed. The temperature of the hydrogen may be obtained by any suitable means, such as measured, calculated, estimated, input by a user, inferred from process information, obtained from an external transducer, etc. The temperature of the hydrogen may be viewed as driving the kinetics of the diffusion and solubility of the hydrogen. Accordingly, the higher the temperature, the faster the hydrogen will diffuse through the lattice and the higher the total hydrogen solubility.

The hydrogen pressure may be a pressure of a substantially pure fluid of hydrogen. Accordingly, the measured or total pressure may be the hydrogen pressure. A fluid comprised almost entirely of hydrogen may be considered substantially pure if the measured or total pressure can be used as the hydrogen pressure in the above equation [5] to accurately predict, for example, an elastic modulus change. For example, a small amount of non-hydrogen components may be employed in the substantially pure fluid of hydrogen when such components do not cause a greater than, for example, 0.1 percent difference in a calculated equilibrium concentration of hydrogen C_{H}_{₂} or, alternatively, a 0.1 percent difference in the elastic modulus of a material of a vibratory element. Other standards and/or parameters may be employed to determine whether a process fluid is substantially pure hydrogen.

The hydrogen pressure may also be a partial pressure of a hydrogen component in a mixture. The partial pressure can be determined by, for example, Dalton's law of partial pressure that determines a partial pressure by multiplying the number of moles of a gas component by a pressure of the mixture. By way of illustration, a mixture in an enclosed container being measured by a fork meter may have a known mass ratio of components. This mass ratio may be converted into the number of moles of each gas component. Accordingly, the total pressure of the mixture in the enclosed container may be multiplied by the number of moles of hydrogen to determine the partial pressure of the hydrogen in the mixture. Alternative methods may be used to determine a partial pressure of hydrogen in a mixture.

A linear relationship, which may be referred to as an elastic modulus-to-concentration change ratio μ, can be developed from the information in Table 1 that relates the hydrogen concentration with a change in elastic modulus, although any suitable data or relationship may be employed. The elastic modulus-to-concentration change ratio μ may have dimensions of a modulus of elasticity per parts per million (E/ppm). The average incremental shift in elastic modulus over a defined time frame can then be calculated by:

$$Δ E = μ ( {C}_{{H}_{2}} * \overline{C} ) ; \qquad [ 6 ]$$

where:
ΔE is a change in elastic modulus of a metal;
μ is an elastic modulus-to-concentration change ratio;
C_{H}_{₂} is an equilibrium concentration of hydrogen; and
C̅ is a fraction of the equilibrium concentration of the hydrogen in the metal as a fraction of the equilibrium concentration.
   Because the effect of change in the elastic modulus of the vibratory element is integrated over time, the accumulated effect may preferably be summed over time, which may be expressed as follows:

$$Δ {E}_{total} = {\sum }_{a = 1}^{n} μ ( {C}_{{H}_{2}} ( a ) * \overline{C} ( a ) ) ; \qquad [ 7 ]$$

where the concentrations are calculated over a time period a. As expressed in equation [6], the accumulated change in elastic modulus ΔEₜₒₜₐₗ of the vibratory element is integrated over a number n of time increments a. Therefore, a change in an elastic modulus of a vibratory element comprising the steels of Table 1 may be determined, although the above may be applied to any suitable material.

The elastic modulus may be related to one or more calibration factors of a vibratory meter. Accordingly, a change in a calibration coefficient of a vibratory meter can therefore be estimated, allowing for an adjusted calibration coefficient, based on a change in the elastic modulus of a vibratory element, as the following discusses in more detail.

### Vibratory Meters with Conduits

For a conduit comprising a cylindrical tube with thin walls and long diffusion times, the solution to Fick's second law of diffusion can be expressed as:

$$\overline{C} = 1 - \frac{4}{{ζ}^{2}} exp [ \frac{- {ζ}^{2} Dt}{{l}^{2}} ] ; \qquad [ 8 ]$$

where:
C̅ is an average concentration as a fraction of an equilibrium concentration;
ζ is a constant;
l is a wall thickness of the cylindrical tube;
D is the diffusivity of hydrogen; and
t is a pre-determined amount of time over which temperature and pressure are averaged. For many processes in which a vibratory meter is used, the pre-determined time over which the temperature and pressure are averaged may be on the scale of days to weeks, although other time scales may be employed. Regardless, the diffusivity can be readily calculated if the average temperature is known.

A flow calibration factor of a conduit may be directly related to elastic modulus. Accordingly, an elastic modulus scaled flow calibration factor FCF′ can be expressed as:

$${FCF}^{′} = FCF [ 1 + \frac{Δ E}{E} ] ; \qquad [ 9 ]$$

where:
FCF is a reference flow calibration factor;
FCF′ is an elastic modulus scaled calibration factor;
E is a reference elastic modulus or an elastic modulus that resulted in the reference flow calibration factor; and
ΔE is a change in elastic modulus of the vibratory element from the reference elastic modulus E.

Accordingly, a hydrogen loading corrected mass flow rate may be determined, by modifying the above equation [1], as follows:

$${\dot{m}}_{HLcorr} = {FCF}^{′} ( Δ t - Δ {t}_{zero} ) ; \qquad [ 10 ]$$

where FCF′ is an elastic modulus scaled flow calibration factor and \dot{m}_{HLcorr} is a hydrogen loading corrected mass flow rate. The hydrogen loading corrected mass flow rate \dot{m}_{HLcorr} may therefore be correctly calculated if hydrogen loading occurs in conduits, such as the conduits 130a, 130a′ discussed above. Similar results can be obtained with density values, such as those obtained by the vibratory meter 5b comprising a fork meter discussed above with reference to FIG. 4.

### Fork Meter

For the vibratory elements 130b comprising the first and second tine 130bd, 130bs, the average concentration of hydrogen may be calculated using the following equation:

$$\overline{C} = 1 - \frac{8}{{π}^{2}} exp ( \frac{- t {π}^{2} D}{4 {L}^{2}} ) ; \qquad [ 11 ]$$

where L is the thickness of a fork tine.

Referring to above equation [2], the second calibration coefficient C₂ does not depend on an elastic modulus of the vibratory element 130b, whereas the first calibration coefficient C₁ does. Similar to the flow calibration factor FCF discussed above, the relationship between the first calibration coefficient C₁ and the elastic modulus is linear.

Therefore, the first calibration coefficient C₁ may be adjusted as follows:

$${C}_{1}^{′} = {C}_{1} [ 1 + \frac{Δ E}{E} ] ; \qquad [ 12 ]$$

where:
C₁ is a reference first calibration coefficient;
C₁′ is an elastic modulus scaled first calibration coefficient;
E is a reference elastic modulus or an elastic modulus that resulted in the reference first calibration coefficient; and
ΔE is the calculated shift in elastic modulus.

Accordingly, a hydrogen loading corrected density can be determined modifying equation [2] as follows:

$${ρ}_{HLcorr} = {C}_{1}^{′} {τ}^{2} + {C}_{2} . \qquad [ 13 ]$$

where ρ_{HLcorr} is the hydrogen loading corrected density.

As can be appreciated, the foregoing Table 1 and equations, as well as any other suitable data, equations, relationships, or the like, may be used in a routine that is performed in an electronic circuit, such as the meter electronics 20 discussed above. The following describes an exemplary configuration of the meter electronics 20.

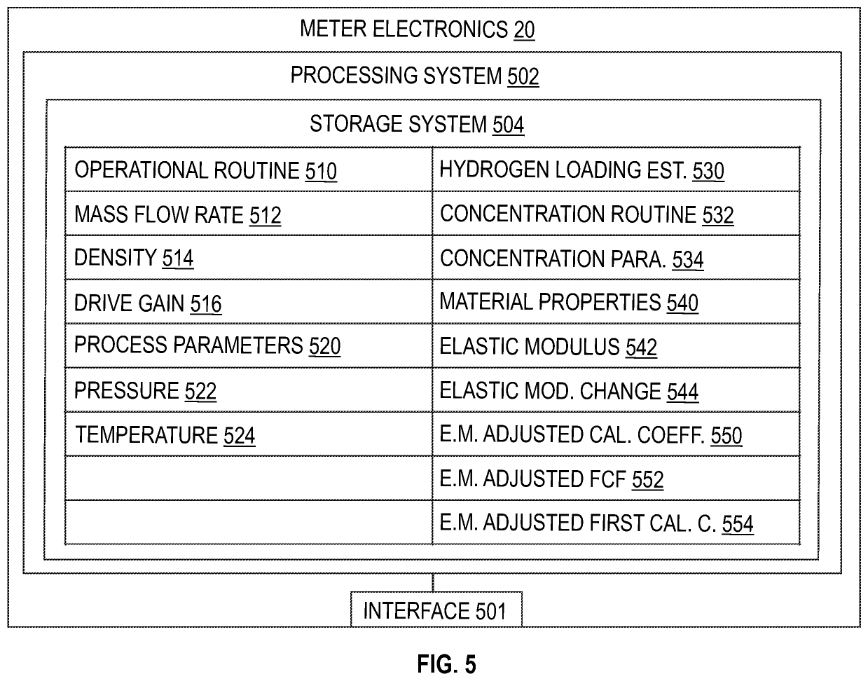

FIG. 5 shows the meter electronics 20 configured to estimate a hydrogen loading induced change in a vibratory meter 5. As shown in FIG. 5, the meter electronics 20 includes an interface 501 and a processing system 502. The meter electronics 20 receives a vibrational response from a sensor assembly, such as the sensor assembly 10 described above, for example. The meter electronics 20 can process the vibrational response to obtain flow properties of the flow material flowing through the sensor assembly 10. The meter electronics 20 may also perform checks, verifications, calibration routines, and/or the like, to ensure the flow properties of the flow material are accurately measured.

With reference to the vibratory meter 5a discussed above with reference to FIGS. 2 and 3, the interface 501 may receive the sensor signals 165a from one of the pick-off sensors 170al, 170ar shown in FIGS. 2 and 3. The interface 501 may also be configured to receive a drive signal 185a from, for example, the signal conditioner 240a. Although the drive signal 185a is shown as being provided by signal conditioner 240a, a back-EMF may be provided from the sensor assembly 10a to the meter electronics 20 due to vibration of the conduits 130a in the sensor assembly 10a. Accordingly, the interface 501 may be configured to receive the communication channels 100a shown in FIGS. 2 and 3. With respect to the vibratory meter 5b shown in FIG. 4, the interface 501 may provide a drive signal to the first piezo element 122b and receive a sensor signal from the second piezo element 124b.

The interface 501 can perform any necessary or desired signal conditioning, such as any manner of formatting, amplification, buffering, etc. Alternatively, some or all of the signal conditioning can be performed in the processing system 502. In addition, the interface 501 can enable communications between the meter electronics 20 and external devices. The interface 501 can be capable of any manner of electronic, optical, or wireless communication. The interface 501 can provide information based on the vibrational response. The interface 501 may be coupled with a digitizer, such as the CODEC 222a shown in FIG. 3, wherein the sensor signal comprises an analog sensor signal. The digitizer samples and digitizes an analog sensor signal and produces a digitized sensor signal.

The processing system 502 conducts operations of the meter electronics 20 and processes fluid measurements from the sensor assembly 10. The processing system 502 executes one or more processing routines and thereby processes the fluid measurements in order to produce one or more fluid properties. The processing system 502 is communicatively coupled to the interface 501 and is configured to receive the information from the interface 501.

The processing system 502 can comprise a general-purpose computer, a micro-processing system, a logic circuit, or some other general purpose or customized processing device. Additionally, or alternatively, the processing system 502 can be distributed among multiple processing devices. The processing system 502 can also include any manner of integral or independent electronic storage medium, such as the storage system 504.

The storage system 504 can store vibratory meter parameters and data, software routines, constant values, and variable values. In one embodiment, the storage system 504 includes routines that are executed by the processing system 502, such as an operational routine 510. The processing system 502 may further be configured to execute other routines such as a zero-calibration routine and zero-verification routine of the vibratory meter 5. The storage system can also store statistical values, such as a mean, standard deviation, confidence interval, etc., or the like.

The operational routine 510 may determine a mass flow rate 512, a density 514, and a drive gain 516 based on the sensor signals received by the interface 501. The mass flow rate 512 may be comprised of a directly measured mass flow rate value, as described above, or the like. The mass flow rate 512 may be determined from the sensor signals, such as a time delay between a left pick-off sensor signal and a right pick-off sensor signal. The density 514 may also be determined from the sensor signals by, for example, determining a frequency from one or both of the left and right pick-off sensor signals, as is described above. An alternative storage system, such as, for example, of the meter electronics 20b described with reference to FIG. 4, may not include a mass flow rate.

The term drive gain may refer to a measure of the amount of power needed to drive the vibratory elements to specified amplitude, although any suitable definition may be employed. For example, the term drive gain may, in some embodiments, refer to drive current, pickoff voltage, or any signal measured or derived that indicates the amount of power needed to drive the vibratory elements at a particular amplitude. The drive gain may be used to detect multi-phase flow by utilizing characteristics of the drive gain, such as, for example, noise levels, standard deviation of signals, damping-related measurements, and any other means known in the art to detect mixed-phase flow. In the vibratory meter 5a described with reference to FIGS. 2 and 3, these metrics may be compared across the pick-off sensors 170al and 170ar to detect a mixed-phase flow.

The storage system 504 is also shown as storing process parameters 520. The process parameters 520 include a pressure 522 and a temperature 524, although alternative and more or fewer process parameters may be stored. As shown in FIG. 5, the pressure 522 may be a pressure of a process fluid in the conduits 130a, 130a′. The pressure may be provided by, for example, a pressure sensor that is part of the sensor assembly 10 or outside the sensor assembly 10. By way of illustration, referring to FIG. 2, a pressure sensor may be mechanically coupled with a pipeline that is mechanically coupled to the inlet end 104a or the outlet end 104a′. With respect to FIG. 4, a pressure sensor may be mechanically coupled to a container having a process fluid that is being sensed by the vibratory meter 5b. Regardless of the location, the pressure sensor may be communicatively coupled with the meter electronics 20. Similarly, the temperature 524 may be provided by a temperature sensor inside or outside a vibratory sensor 10. For example, with reference to the vibratory sensor 10 described with reference to FIGS. 2 and 3, the temperature 524 may be provided by the RTD 190a.

As shown in FIG. 5, the storage system 504 also includes hydrogen loading estimation 530. The hydrogen loading estimation 530 may include routines used to calculate values of hydrogen loading parameters. As shown, the hydrogen loading estimation 530 includes a concentration routine 532 and concentration parameters 534. The concentration routine 532 may be an algorithm that calculates one or more values of the concentration parameters 534. For example, the concentration routine 532 may obtain the pressure 522 and the temperature 524 of the hydrogen in the process fluid and perform the calculations described above to determine a concentration of the hydrogen in the vibratory element. For example, the concentration of hydrogen may be determined using above Table 1 and equation [5], although any suitable data and routine may be employed.

The storage system 504 may also include material properties 540. The material properties 540 may include any suitable material properties of the vibratory elements of the sensor assembly 10. As shown, the material properties 540 includes an elastic modulus 542 of the vibratory sensor 10, although alternative and/or additional material properties may be employed. For example, it may be advantageous to store temperature-to-strain data, stress-to-strain data, etc. The elastic modulus 542 of FIG. 5 may be in units of gigapascals, although any suitable unit or units may be employed. The elastic modulus 542 may, for example, be an original elastic modulus provided in any suitable manner, such as input from a data sheet related to the vibratory element, inferred from a meter verification, or the like. The material properties 540 also include an elastic modulus change 544. The elastic modulus change 544 may be determined from the concentration parameters 534 as described above. For example, the processing system 502 may be configured to calculate the elastic modulus change 544 by using above equations [5]-[7], although any suitable equations may be employed.

The storage system 504 also includes elastic modulus adjusted calibration coefficients 550. As shown in FIG. 5, the elastic modulus adjusted calibration coefficients 550 include an elastic modulus adjusted FCF 552 and an elastic modulus adjusted first calibration coefficient 554. The elastic modulus adjusted FCF 552 may be a value determined using equation [9]. That is, the elastic modulus adjusted FCF 552 may be an elastic modulus scaled flow calibration factor. Similarly, the elastic modulus adjusted first calibration coefficient 554 may be a value determined using above equation [12]. That is, the elastic modulus adjusted first calibration coefficient 554 may be the elastic modulus scaled first calibration coefficient discussed above of equation [12]. The above equations [9] and [12] employs elastic modulus scaled change, although any suitably adjusted flow or first calibration factors may be employed. For example, a routine other than scaling may be employed to adjust a flow calibration factor that was determined prior to hydrogen loading of a vibratory element of the vibratory meter 5. For example, non-linear equations may be employed.

Accordingly, the mass flow rate 512 and density 514 may include corrected mass flow rate and density values. For example, the mass flow rate 512 may include uncorrected or raw mass flow rate values and hydrogen loading corrected mass flow rate values. The hydrogen loading corrected mass flow rate values may be determined using above equation [10]. Similarly, the density 514 may include uncorrected or raw density values and hydrogen loading corrected density values. The hydrogen loading corrected density values may be determined using above equation [13] although any suitable relationship, routine, or the like, may be employed.

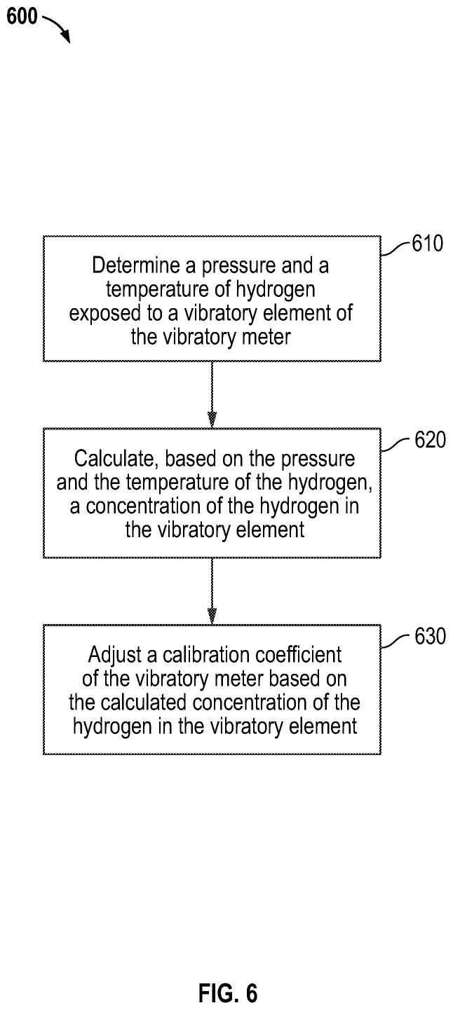

FIG. 6 shows a method 600 of estimating a hydrogen loading induced change in a vibratory meter. The method 600 may be executed by the meter electronics 20 discussed above, although any suitable meter electronics may be employed. As shown in FIG. 6, the method 600 determines a pressure and a temperature of hydrogen exposed to a vibratory element of the vibratory meter in step 610. In step 620, the method 600 calculates, based on the pressure and the temperature of the hydrogen, a concentration of the hydrogen in the vibratory element. The method 600, in step 630 adjusts a calibration coefficient of the vibratory meter based on the calculated concentration of the hydrogen in the vibratory element.

The method 600 may be applied to any suitable vibratory meter, such as the vibratory meter 5 discussed above. For example, the vibratory element 130 may be one of a conduit 130a, 130a′ containing a process fluid. Alternatively, the vibratory element 130 may be a tine, such as the first and second tines 130bd, 130bs discussed above, immersed in the process fluid. Additionally, Fick's second law may have varying solutions depending on the conduit wall or tine thickness and time periods chosen for integration. Accordingly, Fick's second law may have alternative forms depending on the geometry of the vibratory element 130.

The process fluid that is exposed to the vibratory element may be a substantially pure fluid of hydrogen. For example, the process fluid may be comprised of 99.99 percent pure hydrogen, although any suitable purity may be employed in a substantially pure fluid of hydrogen. Alternatively, the process fluid may be a mixture containing hydrogen. By way of illustration, the mixture may be comprised of an inert gas, such as helium, and hydrogen gas, although any suitable mixture may be employed.

The step 610 of determining a pressure of the hydrogen may comprise determining a total pressure of the substantially pure fluid of hydrogen or a partial pressure of the hydrogen in a mixture. For example, if the process fluid is a substantially pure fluid of hydrogen, then a measured pressure of the process may be employed. Alternatively, if the process fluid is a mixture that includes hydrogen, then a measured pressure may be used to determine a partial pressure of the hydrogen, as is described above. This partial pressure may be used as the pressure of the hydrogen when determining a concentration of the hydrogen in the vibratory element.

The hydrogen may be in any suitable phase or in any form. For example, the hydrogen may be in a gas phase or a liquid phase. By way of illustration, the process fluid may be a substantially pure fluid of hydrogen in gaseous form. The hydrogen may be molecular form and an atomic form. The molecular form of hydrogen may be defined as two hydrogen atoms in a diatomic form. Additionally, or alternatively, the process fluid may include atomic hydrogen. Atomic hydrogen may be defined as an atom of hydrogen. The hydrogen that diffuses into the vibratory element may be of molecular or atomic form and may be in a form that is the same as or differs from the form of the process fluid.

The step 620 of calculating a concentration of the hydrogen in the vibratory element may comprise calculating an average concentration of the hydrogen as a fraction of an equilibrium concentration. For example, an average concentration of a fraction of an equilibrium concentration in the conduits 130a, 130a′ described with reference to FIG. 2 may be calculated by using the above equation [8]. Similarly, an average concentration of an equilibrium concentration of hydrogen in the first and second tine 130bd, 130bs described with reference to FIG. 4 may be calculated with above equation [11].

The step 630 of adjusting a calibration coefficient may comprise calculating a change in an elastic modulus of the vibratory element based on a concentration of hydrogen in the vibratory element and calculating an elastic modulus scaled calibration coefficient based on the change in the elastic modulus. By way of illustration, the values obtained from equations [8] and [11] may be used in above equation [5] to determine a change in elastic modulus. This change in elastic modulus can be accumulated according to equation [7]. Calculating the elastic modulus scaled calibration coefficient based on the change in the elastic modulus may comprise using above equations [9] and [12], although any suitable equations may be employed.

The vibratory meter 5, meter electronics 20, and the method 600 described above estimate a hydrogen loading induced change in the vibratory meter 5. In particular, the vibratory meter 5, the meter electronics 20, and the method 600 may obtain a pressure and temperature of hydrogen in a process fluid to calculate a concentration of hydrogen in a lattice of a vibratory element. Data or relationships that relate a change in elastic modulus to the concentration of the hydrogen in the lattice is used to determine a change in the elastic modulus. Since an elastic modulus of a vibratory element has a direct relationship with calibration coefficients of a vibratory element, a change in calibration coefficient may be determined from the change in elastic modulus.

Accordingly, changes to a calibration coefficient may be estimated without performing a calibration of the vibratory meter 5. This can be used to determine if the reference calibration coefficient still results in measurement values that are within a specification. Additionally, or alternatively, a hydrogen loading corrected measurement value may be obtained. For example, a hydrogen loading corrected mass flow rate value and/or a hydrogen loading corrected density value may be obtained.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other embodiments estimating a hydrogen induced change in a vibratory meter and not just to the embodiments described above and shown in the accompanying figures. Accordingly, the scope of the embodiments described above should be determined from the following claims.

We claim:

1. A method for estimating a hydrogen loading induced change in a vibratory meter, the method comprising:
determining a pressure and a temperature of hydrogen exposed to a vibratory element of the vibratory meter;
calculating, based on the pressure and the temperature of the hydrogen, a concentration of the hydrogen in the vibratory element; and
adjusting a calibration coefficient of the vibratory meter based on the calculated concentration of the hydrogen in the vibratory element.

2. The method of claim 1, wherein the vibratory element is one of a conduit and a tine.

3. The method of claim 1, wherein the process fluid is one of a pure fluid of the hydrogen and a mixture containing the hydrogen.

4. The method of claim 3, wherein determining a pressure of the hydrogen comprises determining one of a total pressure of the pure fluid of the hydrogen and a partial pressure of the hydrogen in the mixture.

5. The method of claim 1, wherein the hydrogen is in at least one of a gas phase and a liquid phase and/or in at least one of a molecular form and an atomic form.

6. The method of claim 1, wherein calculating the concentration of the hydrogen in the vibratory element comprises calculating an average concentration as a fraction of an equilibrium concentration.

7. The method of claim 1, wherein adjusting the calibration coefficient of the vibratory meter comprises calculating a change in an elastic modulus of the vibratory element based on the concentration of the hydrogen in the vibratory element and calculating an elastic modulus scaled calibration coefficient based on the change in the elastic modulus.

8. The method of claim 7, wherein calculating the change in the elastic modulus of the vibratory element comprises using equation:
$$Δ E = μ ( {C}_{{H}_{2}} * \overline{C} ) ;$$
where:
ΔE is a change in elastic modulus of a metal;
μ is an elastic modulus-to-concentration change ratio;
C_{H}_{₂} is an equilibrium concentration of hydrogen; and
C̅ is a fraction of the equilibrium concentration of the hydrogen in the metal.

9. The method of claim 7, wherein calculating the elastic modulus scaled calibration coefficient based on the change in the elastic modulus comprises using equation:
$${FCF}^{′} = FCF [ 1 + \frac{Δ E}{E} ] ;$$
where:
FCF is a reference flow calibration factor;
FCF′ is an elastic modulus scaled flow calibration factor;
E is a reference elastic modulus or an elastic modulus that resulted in the reference flow calibration factor; and
ΔE is a change in elastic modulus of the vibratory element from the reference elastic modulus E.

10. The method of claim 7, wherein calculating the elastic modulus scaled calibration coefficient based on the change in the elastic modulus comprises using the equation:
$${C}_{1}^{′} = {C}_{1} [ 1 + \frac{Δ E}{E} ] ;$$
where:
C₁ is a reference first calibration coefficient;
C₁′ is an elastic modulus scaled first calibration coefficient;
E is a reference elastic modulus or an elastic modulus that resulted in the reference first calibration coefficient; and
ΔE is a change in elastic modulus of the vibratory element from the reference elastic modulus E.

11. A vibratory meter (5) configured to estimate a hydrogen loading induced change in the vibratory meter (5), the vibratory meter (5) comprising:
a sensor assembly (10) having a vibratory element (130) configured to be exposed to hydrogen in a process fluid;
a meter electronics (20) communicatively coupled to the sensor assembly (10), the meter electronics (20) being configured to:
determine a pressure and a temperature of the hydrogen;
calculate, based on the pressure and the temperature of the hydrogen, a concentration of the hydrogen in the vibratory element (130); and
adjust a calibration coefficient of the vibratory meter based on the calculated concentration of the hydrogen in the vibratory element (130).

12. The vibratory meter (5) of claim 11, wherein the vibratory element (130) is one of a conduit (130a, 130a′) and a tine (130bd, 130bs).

13. The vibratory meter (5) of claim 11, wherein the process fluid containing the hydrogen is one of a pure fluid of the hydrogen and a mixture containing the hydrogen.

14. The vibratory meter (5) of claim 13, wherein the meter electronics (20) being configured to determine a pressure of the hydrogen comprises the meter electronics (20) being configured to determine one of a total pressure of the pure fluid of the hydrogen and a partial pressure of the hydrogen in the mixture.

15. The vibratory meter (5) of claim 11, wherein the hydrogen is in at least one of a gas phase and a liquid phase and/or in at least one of a molecular form and an atomic form.

16. The vibratory meter (5) of claim 11, wherein the meter electronics (20) being configured to calculate the concentration of the hydrogen in the vibratory element (130) comprises the meter electronics (20) being configured to calculate an elastic modulus of the vibratory element (130) based on the pressure and the temperature of the hydrogen in the process fluid.

17. The vibratory meter (5) of claim 11, wherein the meter electronics (20) being configured to adjust the calibration coefficient of the vibratory meter (5) comprises the meter electronics (20) being configured to calculate a change in an elastic modulus of the vibratory element (130) based on the concentration of the hydrogen in the vibratory element (130) and calculating an elastic modulus scaled calibration coefficient based on the change in the elastic modulus.

18. The vibratory meter (5) of claim 17, wherein the meter electronics (20) being configured to calculate the change in the elastic modulus of the vibratory element comprises using equation:
$$Δ E = μ ( {C}_{{H}_{2}} * \overline{C} ) ;$$
where:
ΔE is a change in elastic modulus of a metal;
μ is an elastic modulus-to-concentration change ratio;
C_{H}_{₂} is an equilibrium concentration of hydrogen; and
C̅ is a fraction of the equilibrium concentration of the hydrogen in the metal.

19. The vibratory meter (5) of claim 17, wherein the meter electronics (20) being configured to calculate the elastic modulus scaled calibration coefficient based on the change in the elastic modulus comprises the meter electronics (20) being configured to use equation:
$${FCF}^{′} = FCF [ 1 + \frac{Δ E}{E} ] ;$$
where:
FCF is a reference flow calibration factor;
FCF′ is an elastic modulus scaled flow calibration factor;
E is a reference elastic modulus or an elastic modulus that resulted in the reference flow calibration factor; and
ΔE is a change in elastic modulus of the vibratory element from the reference elastic modulus E.

20. The vibratory meter (5) of claim 17, wherein the meter electronics (20) being configured to calculate the elastic modulus scaled calibration coefficient based on the change in the elastic modulus comprises the meter electronics (20) being configured to use the equation:
$${C}_{1}^{′} = {C}_{1} [ 1 + \frac{Δ E}{E} ] ;$$
where:
C₁ is a reference first calibration coefficient;
C₁′ is an elastic modulus scaled first calibration coefficient;
E is a reference elastic modulus or an elastic modulus that resulted in the reference first calibration coefficient; and
ΔE is the calculated shift in elastic modulus of the vibratory element from the reference elastic modulus E.
